(19) United States
(12) Patent Application Publication
(10) Pub. No.: US 2012/0043285 A1
(43) Pub. Date: Feb. 23, 2012

(54) MANURE SEPARATOR

(76) Inventor: Michael van Logtenstein, Komoka (CA)

(21) Appl. No.: 12/861,051

(22) Filed: Aug. 23, 2010

(51) Int. Cl. B01D 33/06

(52) U.S. Cl. 210/780; 210/386

(57) ABSTRACT

The present invention relates to a device for separating moisture out of a material, such as manure, paper pulp or the like. The device of the invention comprises two or more perforated draining rollers having a main longitudinal axis and two or more pressing rolls having an axis parallel to the main longitudinal axis of the draining rollers. Each pressing roll is pressed against only one draining roller thereby forming a pressing way between the pressing rolls and the draining rollers to press the moisture out of the material flowing through the pressing way. The device also comprises a positive drive system for rotating just the draining rollers. The pressing rolls are driven by a friction with the draining rollers, thereby ensuring that the device does not stall.

### FIELD OF THE INVENTION

The present invention relates to separation of solids from liquids in materials such as manure or the like. More particularly, the present invention relates to a press for squeezing moisture out of materials such as manure or the like, for separating the solids and liquids from the material.

### BACKGROUND OF THE INVENTION

Previous machines used to separate solids out of materials such as manure using rollers either are bulky, complex and requiring regular maintenance or do not squeeze out enough liquid from the material.

U.S. Pat. No. 6,044,980 discloses an apparatus for extracting liquids from a slurry formed of liquids and fibers, like diluted manure or paper mills residue. The apparatus has a rotatable drum covered with a resilient layer and two draining rolls which are pressed against the drum so that the slurry passing in between is squeezed. Each draining roll has a hollow cylindrical shell with a uniform distribution of openings. The apparatus also has a pair of wipers in order to wipe the fibers out of the draining rolls and guide the liquids collected in the shells towards a liquids outlet. A reservoir can be mounted above the drum and upper draining roll for receiving the slurry, storing it to build-up a constant pressure, and supplying it in a continuous manner. The apparatus of U.S. Pat. No. 6,044,980 is substantially vertical and the draining rolls are not linked together, therefore, susceptible to stall.

It is necessary to provide for a device useful for separating moisture out of materials such as manure that are simple and designed to be a “walk away” unit meaning that once it is installed it does not require regular maintenance.

It is therefore an object of the invention to obviate or minimize the disadvantages of the known presses, and to provide a machine in which stalls are avoided.

### SUMMARY OF THE INVENTION

In one aspect, the present invention relates to a device for separating moisture out of a material, such as manure, paper pulp or the like, said device comprising:

(a) two or more perforated draining rollers having a main longitudinal axis, wherein said draining rollers are linked together by a first linking means;
(b) two or more pressing rolls having an axis parallel to the main longitudinal axis of the draining rollers, wherein said pressing rolls are linked together by a second linking means; and
(c) a positive drive system for rotating the draining rollers about the main longitudinal axis by engaging the first linking means,
wherein each pressing roll is pressed against only one draining roller thereby forming a pressing way between the pressing rolls and the draining rollers to press the moisture out of the material flowing through the pressing way, and wherein the pressing rolls are driven by a friction with the draining rollers, thereby ensuring that the device does not stall.

In another aspect of the present invention, the press device for separating moisture out of a material further comprises an elongated frame inclined longitudinally, said frame including a bottom portion and an upper portion, wherein the draining rollers are mounted to the bottom portion of the frame and the pressing rolls are mounted to the upper portion of the frame.

In a further aspect, the device of the present invention further comprises a spray cleaning system for cleaning the draining rollers and pressing rolls.

In yet a further aspect, the device of the present invention further includes a draining pipe for discharging the moisture separated out of the material.

Advantages of the device of the present invention include a device that is simple, small, and designed for easy maintenance. The linking of the rollers ensures that the device does not stall, plug or over flow.

### BRIEF DESCRIPTION OF THE DRAWINGS

The present invention will become more fully understood from the detailed description given herein and from the accompanying drawings, which are given by way of illustration only and do not limit the intended scope of the invention.

FIG. 1a illustrates a side view according to one aspect of the device of the invention.

FIG. 1b illustrates a bottom view according to one aspect of the device of the invention.

FIG. 1c illustrates a bottom view according to one aspect of the device of the invention

FIG. 1d illustrates a bottom perspective view according to one aspect of the device of the invention.

FIGS. 2a, b and c illustrate a torsion arm in front, side and top views according to one aspect of the device of the invention.

FIG. 3a illustrates an upper view of a frame according to one aspect of the device of the invention.

FIG. 3b illustrates a side view of a frame according to one aspect of the device of the invention.

FIG. 4 illustrates a stripping means assembly.

FIG. 5a illustrates a cross section along the longitudinal axis of a pressing roll according to one aspect of the present invention.

FIG. 5b illustrates a cross section of a pressing roll according to one aspect of the present invention.

FIG. 6a illustrates a cross section of a draining roller according to one aspect of the present invention.

FIG. 6b illustrates a cross section along the longitudinal axis of a draining roller according to one aspect of the present invention.

### DETAILED DESCRIPTION OF THE INVENTION

The present invention is useful, without limitation, in livestock industries to receive animal waste usually carried in a slurry with water, to separate liquids from the solids within the waste. The liquids can then be used for further wash purposes or fertilizer. The solids can be sufficiently dried for further use, for example, as bedding. The present invention is also useful in the paper industry for separating moisture out of paper pulp.

The present invention relates to a device for separating moisture out of a material, such as manure, paper pulp or the like, said device comprising:

(a) two or more perforated draining rollers having a main longitudinal axis, wherein said draining rollers are linked together by a first linking means;
(b) two or more pressing rolls having an axis parallel to the main longitudinal axis of the draining rollers, wherein said pressing rolls are linked together by a second linking means; and
(c) a positive drive system for rotating the draining rollers about the main longitudinal axis,
wherein each pressing roll is pressed against only one draining roller thereby forming a pressing way between the pressing rolls and the draining rollers to press the moisture out of the material flowing through the pressing way, and wherein the pressing rolls are driven by a friction with the draining rollers, thereby ensuring that the device does not stall.

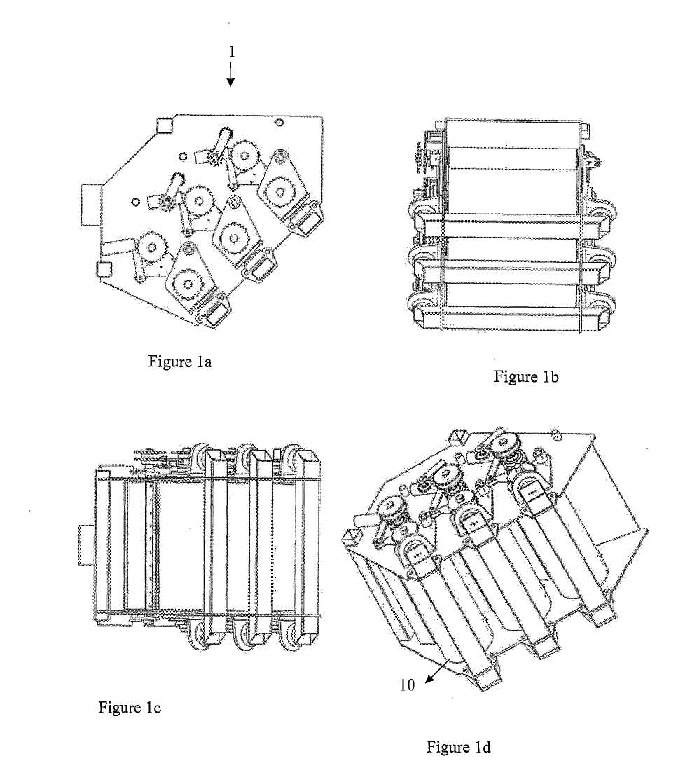

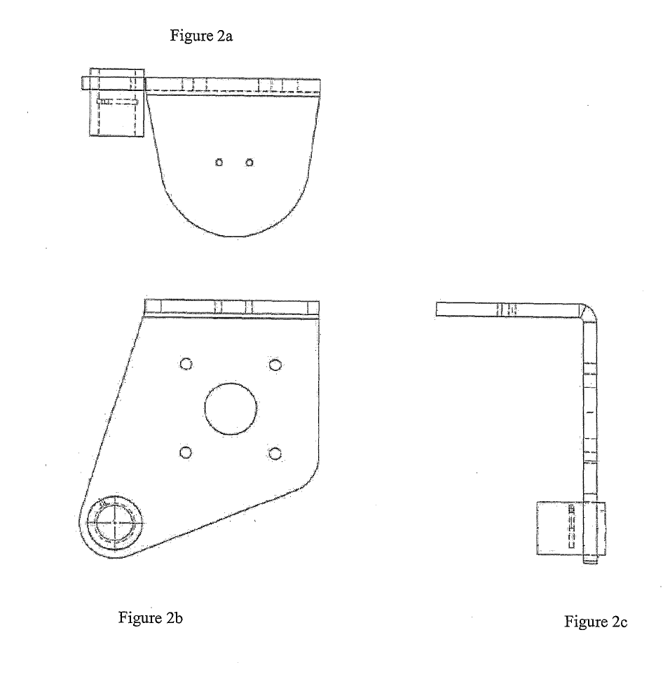

With reference to FIGS. 1 to 6 the press device 1 according to the present invention comprises of a frame having a bottom portion on which draining rollers 10 are mounted, and an upper portion on which pressing rolls 20 are mounted. The number of draining rollers and pressing rolls may vary. In one aspect of the present invention, the number of pressing rolls is equal to the number of draining rollers.

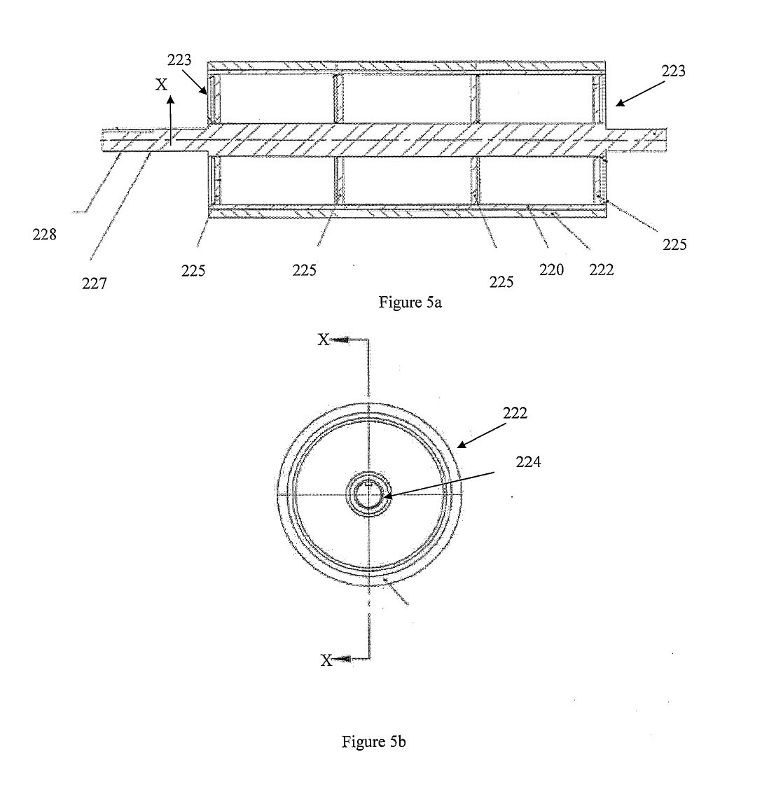

With reference to FIG. 5, a pressing roll 20 is depicted. The pressing roll comprises of a shaft 227 and a drum 220. The drum 220 may take the form of a cylinder having an outer surface 222, two opposite ends 223 and a bore 224 running through the drum 220 along the longitudinal rotating axis X of the upper drum assembly from one end to the other. The shaft 227 runs along the bore 224 and extends beyond the ends 223 of the drum 220 to form the drum's 220 extensions 228. The extensions 228 of the shaft 227 serve to mount the pressing roll to the frame 300. The outer surface 222 is coated with a resilient film, such as a rubber film. In one aspect, the pressing roll is a gum roller, wherein the surface is coated with a gum coating.

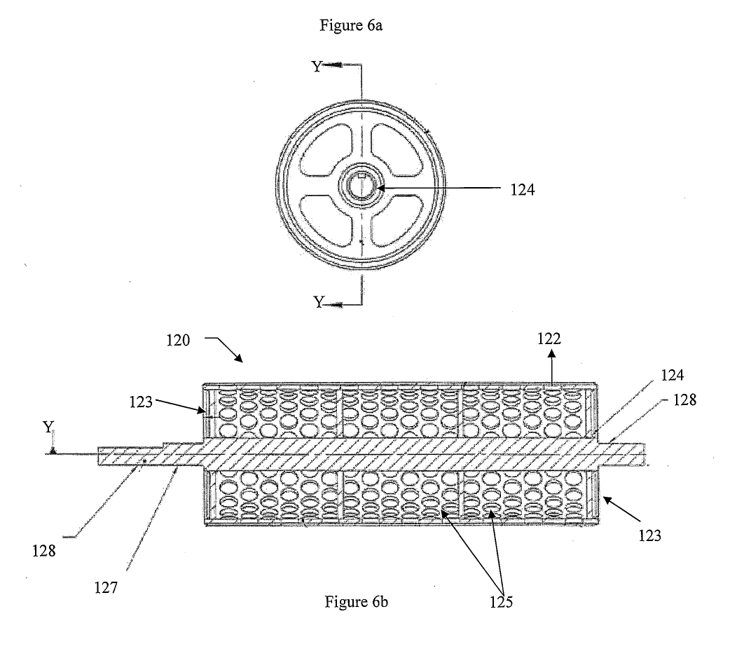

With reference to FIG. 6, a draining roller is depicted. Each draining roller comprises of a shaft 127 and a hollow drum 120 having perforations 125 on its outer surface 122. The hollow drum 120 may take the form of a cylinder having two opposite ends 123 and a bore 124 running along the longitudinal rotating axis 126 of the drum. The shaft 127 runs along the bore 124 and extends beyond the two ends of the drum to form the shaft's extensions 128. The extensions 128 of the shaft 127 serve to mount the draining rollers to the bottom portion of the frame 300. The perforations 125 should be of a size that allows the liquid squeezed from the material being pressed into the draining rollers, while retaining in the descending way the dry components of the material.

Each pressing roll is pressed against only one draining roller, and the main longitudinal axis of pressing rolls 20 is parallel to the main longitudinal axis of the draining rollers 10.

The draining rollers are mounted and extend on a same first plane, while the pressing rolls are mounted and extend on a same second plane, wherein the first plane is parallel and below the second plane. This means that a pressing way is formed between the pressing rolls on the upper portion of the frame 300 and the draining rolls on the bottom portion of the frame 300.

The draining rollers 10 are linked together by a first linking means and their rotation is driven by a positive drive system, such as a motor. Linking means include chains, belts or the like forms of linking. Alternatively, the perforated drums may be linked directly to the positive drive system.

While the pressing rolls 20 are also linked together by a second linking means, the pressing rolls 20 are not driven by a positive system. The pressing rolls 20 are driven by a friction with the inner drums driving by the positive system. This arrangement of the press device of the current invention ensures that press device does not stall and it allows for the material to be pressed to flow between the pressing rolls 20 and the draining rollers 10 and the liquid is pressed out from the material to be pressed. The liquid departs from the material being pressed, through the perforations in the inner drums and out of the press device 1.

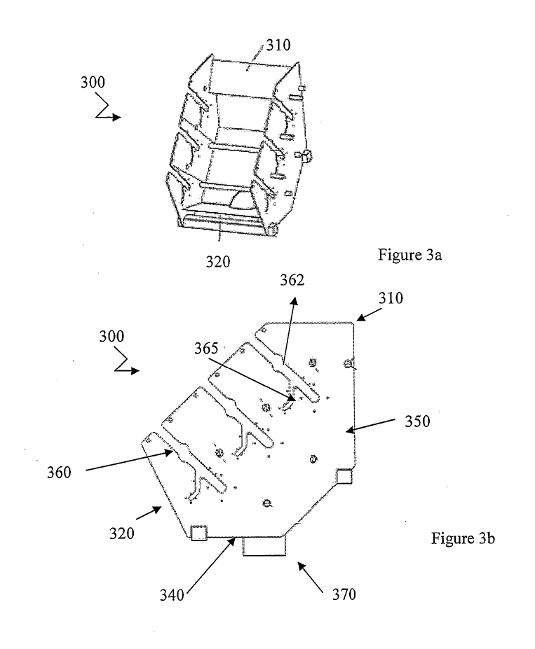

With reference to FIG. 3, the draining rollers 10 and pressing rolls 20 are mounted to an elongated frame 300. The frame 300 can be better described as a frame inclined longitudinally between a top end 310 and a lower end 320. The top end 310 includes an in-feed opening for feeding the material to be pressed into the press device 1. A substantially parallel discharge opening is included in the lower end 320 of the frame 1 and serves for discharging a substantially dried material. A longitudinal descending way formed between the top end 310 and the lower end 320, runs between the press rolls 20 on the upper portion of the frame 300 and the draining rollers 10 on the bottom portion to the frame, communicates the in-feed opening with the discharge opening.

The frame 300 includes a bottom floor 340 and two sidewalls 350. A series of main slots 360 are defined in the sidewalls 350. The main slots 360 run down the sidewalls, from and perpendicular to the top of the sidewalls 350. The bottom end of said main slot 360 serves to accommodate the shaft extensions 228 of the draining rollers. About an upper portion of the main slot 360 a retaining groove 362 is defined. The retainer groove 362 serves to accommodate shaft extensions 128 of the pressing rolls. A series of secondary slots 365 are connected to the main slots 360 and serve to accommodate torsion arms 40. The bottom floor 340 may include one or more draining pipes 370.

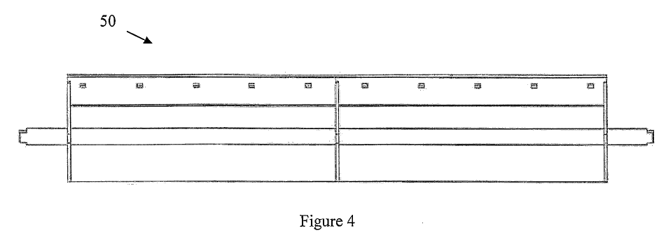

With reference to FIG. 4, the press device may also include a stripping means 50 for stripping the draining rollers 10 off the material being processed by the press device 1. The stripping means 50 may extend across the frame from one sidewall to the other sidewall to engage the main slots 360 formed on said sidewalls and being longitudinally movable relative to said sidewalls by an actuator connected to said stripping means 50.

The bottom floor of the frame 300 may also include a draining pipe for discharging the liquid or moisture separated out from the material.

The press device 1 may also include a spray cleaning system for cleaning the draining rollers and press rolls.

In operation, material dropped to the infeed opening will be guided to the descending longitudinal way. A first set of a rotating pressing roll and draining roller then compress the material received between their converging surfaces and squeeze the contained moisture, liquids through the perforations on the outer surface of the draining roller. The material then continues on to a second, third or more sets of pressing rolls and draining rollers along the longitudinal descending way 330, and at each set more liquid is squeezed out of the material and drained through the draining roller. The dried material then continues downwardly to the discharge opening to drop gravitationally therefrom.

The above disclosure generally describes the present invention. Changes in form and substitution of equivalents are contemplated as circumstances may suggest or render expedient. Although specific terms have been employed herein, such terms are intended in a descriptive sense and not for purposes of limitation.

1. A device for separating moisture out of a combined liquid and solid material said device comprising:
(a) two or more perforated draining rollers having a main longitudinal axis, wherein the draining rollers are linked together by a first linking means;
(b) two or more pressing rolls having an axis parallel to the main longitudinal axis of the draining rollers, wherein the pressing rolls are linked together by a second linking means; and
(c) a positive drive system for rotating the draining rollers about the main longitudinal axis,
wherein each pressing roll is pressed against only one draining roller thereby forming a pressing way between the pressing rolls and the draining rollers to press the moisture out of the material flowing through the pressing way, and wherein the pressing rolls are driven by a friction with the draining rollers, thereby ensuring that the device does not stall.

2. A device for separating moisture out of a combined liquid and solid material said device as claimed in claim 1 wherein the pressing roll further comprise a shaft and a drum having an outer surface.

3. A device for separating moisture out of a combined liquid and solid material said device as claimed in claim 2 wherein the outer surface is coated with an resilient coating.

4. A device for separating moisture out of a combined liquid and solid material said device as claimed in claim 3 wherein the resilient coating is a rubber film or gum coating.

5. A device for separating moisture out of a combined liquid and solid material said device as claimed in claim 1 wherein the perforated draining rollers further comprises a shaft and hollow drum having an outer surface with perforations.

6. A device for separating moisture out of a combined liquid and solid material said device as claimed in claim 5 wherein the perforations are sized to allow liquid to pass.

7. A device for separating moisture out of a combined liquid and solid material said device as claimed in claim 1 further comprises an elongated frame inclined longitudinally, the frame including a bottom portion and an upper portion, wherein the draining rollers are mounted to the bottom portion of the frame and the pressing rolls are mounted to the upper portion of the frame.

8. A device for separating moisture out of a combined liquid and solid material said device as claimed in claim 7 wherein the perforated draining rollers are mounted and extend along a first plane and the pressing rolls are mounted and extend on a same second plane where the first plane is parallel second plane providing a pressing way formed between the pressing rolls on the upper portion of the frame and the perforated draining rollers on the bottom portion of the frame.

9. A device for separating moisture out of a combined liquid and solid material said device as claimed in claim 1 wherein the first linking means includes chains or belts.

10. A device for separating moisture out of a combined liquid and solid material said device as claimed in claim 1 wherein the positive drive system only drives the perforated draining rollers and is a motor.

11. A device for separating moisture out of a combined liquid and solid material said device as claimed in claim 7 further comprising a stripping means extending across the bottom portion of the frame for stripping off of the perforated draining rollers the material.

12. A device for separating moisture out of a combined liquid and solid material said device as claimed in claim 1 further comprising a spray cleaning system mounted to frame for cleaning the perforated draining rollers.

13. A device for separating moisture out of a combined liquid and solid material said device as claimed in claim 7 wherein the frame further comprises a draining pipe for separately discharging the liquid separated from the solid and liquid material.

14. A device for separating moisture out of a combined liquid and solid material said device as claimed in claim 1 wherein the combined liquid and solid material is manure.

15. A device for separating moisture out of a combined liquid and solid material said device as claimed in claim 1 wherein the combined liquid and solid material is pulp.

16. A method of separating moisture out of a combined liquid and solid material of material comprising
(a) dropping into a device having a longitudinally descending in-feed opening the combined liquid and solid material;
(b) compressing against a converging surface of (i) a first set of a rotating pressing roll having an axis parallel to the main longitudinal axis of the draining rollers and are linked together by a second linking means, and (ii) a perforated draining roller having a main longitudinal axis and are linked together by a first linking means, wherein the perforated draining roller is rotatably driven about the main longitudinal axis by a positive drive system but the pressing rolls are driven by a friction with the draining rollers;
(c) squeezing the liquid within the combined liquid and solid material through the perforated draining roller and draining the liquid off through a draining pipe;
(d) compressing against a converging surface of a second set of rotating pressing roll and perforated draining roller along a longitudinal descending path;
(e) squeezing the liquid within the combined liquid and solid material through the perforated draining roller and draining the liquid off through a draining pipe;
(f) compressing against a converging surface of a third set of rotating pressing roll and perforated draining roller along the longitudinal descending path;
(g) squeezing the liquid within the combined liquid and solid material through the perforated draining roller and draining the liquid off through a draining pipe;
(h) discharging gravitationally the solid material within the combined liquid solid material through a discharge opening.
